(19) United States
(12) Patent Application Publication
(10) Pub. No.: US 2009/0126639 A1
(43) Pub. Date: May 21, 2009

(54) APPARATUS FOR UNIFORMLY DISTRIBUTING MATERIALS

(76) Inventor: Jia Hsiung Hsieh, Sijhih City (TW)

Correspondence Address: LOWE HAUPTMAN HAM & BERNER, LLP, 1700 DIAGONAL ROAD, SUITE 300, ALEXANDRIA, VA, 22314, US

(21) Appl. No.: 11/940,854

(22) Filed: Nov. 15, 2007

(51) Int. Cl. A01K 5/02

(52) U.S. Cl. 119/51.11

(57) ABSTRACT

An apparatus for uniformly distributing materials is disclosed, it consists of a container for storing materials, the container has an exit formed at its bottom, under the container, a feeding device is installed opposite to the exit of the container, the feeding device pushes material flows out of the exit of container to a distributing disk. The distributing disk has surface slopes downward from a top conical center portion with a circular furrow formed surrounding the disk. A controller is electrically connected to the driving motor to set up activation time of the apparatus, so that at pre-determined time, the material flows from the exit of container into the feeding device, and then pushed out of the feeding device and evenly lands along the distributing disk and then on its furrow. By this, the object for even distribution of feed at set amount and time to supply feed to birds and the animals is achieved. Furthermore, inside the container, there is an elastic stirring element which can be moved to and fro according to the operation of feeding device, such that the blockage of materials at the exit of container is presented.

### BACKGROUND OF THE INVENTION

1. Field of the Invention

The present invention relates to an apparatus for uniformly distributing materials, especially to an apparatus for conveniently supplying feeds to birds or other animals. And it is able to evenly spread feeds to birds or other animals with fixed amount at fixed time.

2. Description of Prior Art

It is well known to public that some people have pet at home, such as cat, dog, dove, bird, fish, etc. to enrich daily live, this exercise has been very common. However, to those who live a busy life or always busy with works, or to those who are frequently out of town on business or for personal reason, in the work regarding to raising a pet, often because of they are unable to take care of pet's eating, lead to the death of pet by hunger, this is a cause of difficulty when busy people try to raise a pet. Although there are self feeding device for sale in the market, but those are far from ideal when being used, especially none of them is cheap, with easy operation and can uniformly spread fixed amount of feed for pets to eat.

### SUMMARY OF THE INVENTION

In view of the above-mentioned disadvantages found in conventional self feeding device, the inventor of the present invention herein conducted intensive research based on many years of experience obtained through professional engagement in the manufacture of pet related products with continuous experimentation and improvement culminating in the development of the new kind of apparatus for uniformly distributing materials which will be elucidated hereinafter.

According to the apparatus for uniformly distributing materials of the present invention, at a preset time the device can automatically and uniformly deliver certain amount of feeds for pet (e.g. dove) etc. to eat, in this way people's trouble can be resolved, this is the one object of present invention.

According to the above-mentioned object, the apparatus for uniformly distributing materials of present invention consists of a container for storing feeds, inside the container is a base plate for holding feeds in the container, underneath the container is a feeding device having a motor, an exit is formed at the side of bottom of the base plate for supplying feeds to the feeding device, that causes feed which comes from the base plate to fall into the feeding device, and thus be distributed evenly, so the objects of distribution of fixed amount of feed to birds etc. at a preset time is achieved.

Also, according to a practical embodiment of present invention, the interior wall of container near exit of base plate has a connecting member, vertically hanging down from the connecting member is an elastic stirring element, the bottom end of which touches spiral of feeding screw of said feeding device; during feeds delivery, the elastic stirring element moves forward and back by the movement of feeding screw, results in clear the exit of the base plate bottom, to prevent blockage of the exit, which otherwise causes feed unable to flow into feeding device, then the object of automatic distribution of fixed amount of feed at fixed time is achieved.

A more complete understanding of these and other features and advantages of the present invention will become apparent from a careful consideration of the following detailed description of certain embodiments illustrated in the accompanying drawings.

### BRIEF DESCRIPTION OF THE DRAWINGS

FIG. 1 is a perspective view showing the apparatus of uniformly distributing materials for present invention.

FIG. 2 is a cross-sectional view showing the construction of the apparatus of uniformly distributing materials for present invention.

FIG. 3 is an illustrative view showing the application of the apparatus of uniformly distributing materials for present invention in using.

FIG. 4 is a top view of the apparatus of uniformly distributing materials for present invention.

FIG. 5 is a cross-sectional view of another embodiment of the apparatus of uniformly distributing materials for present invention.

FIG. 6 is a perspective view showing the apparatus of uniformly distributing materials for present invention with the stirring component.

FIG. 7 is a cross-sectional view showing the construction of the apparatus of uniformly distributing materials for present invention with the stirring component.

FIG. 8 is an illustrative view showing the application of the apparatus of uniformly distributing materials for present invention with the stirring component in using.

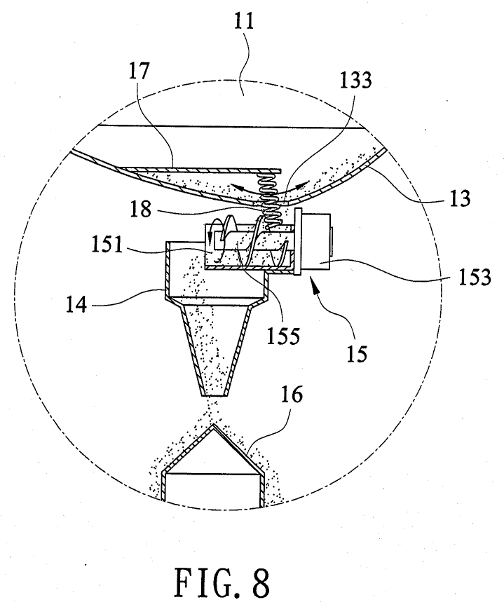

### DETAILED DESCRIPTION OF THE PREFERRED EMBODIMENTS

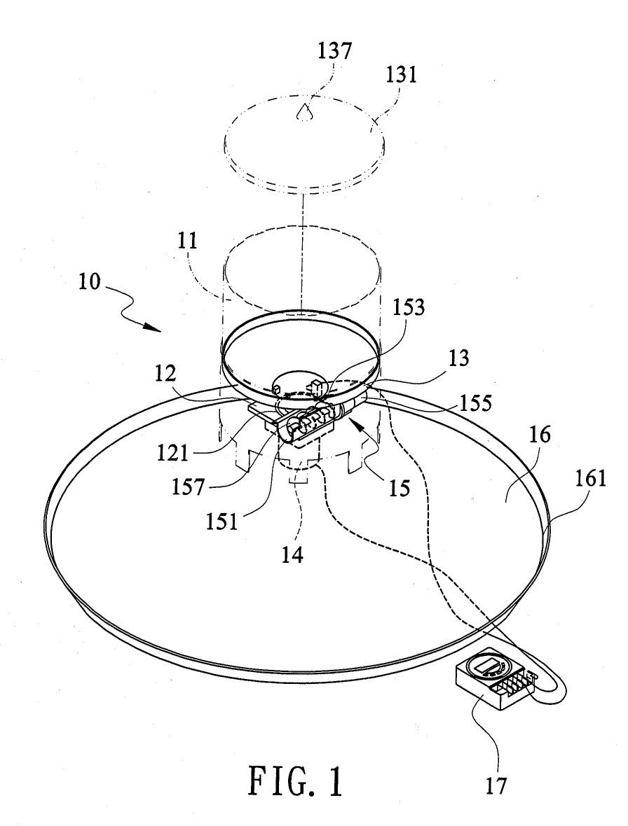

As shown in FIGS. 1, 2 and 3, one embodiment of the apparatus for uniformly distributing materials 10 of the present invention contains a container 11 for storing feeds, inside the storage container 11 lays a platform 12, on top of the platform 12 is a smaller rotational table 121, on the rotational table 121 has a base plate 13 that supports the feeds in the container; below the container 11 is a central motor 14, the central motor 14 is connected to a controller 17, so that the controller 17 can preset the start time of central motor 14; the rotational shaft of central motor 14 is connected to the bottom of base plate 13, so that the base plate 13 can rotate in the container 11 by the activation of central motor 14; at the bottom of base plate 13 is an exit with a feeding device 15 attached, the exit at the bottom of base plate 13 receives feeds from base plate 13 and loads feeds into the feeding device 15, by the movement of feeding device 15, the feed gets distributed out of the container 11; and, directly underneath the base plate 13 is a distributing disk 16 with a shape having a higher central portion and lower surrounding portion formed as a furrow 161, such that the feeds falls out of the feeding device can be distribute evenly along the distributing disk 16 on its furrow 161; on top of container 111 is a cover 131, at center top of the cover 131 is a sharp extrusion 137 for preventing bird (e.g. dove) from stands on the cover 131.

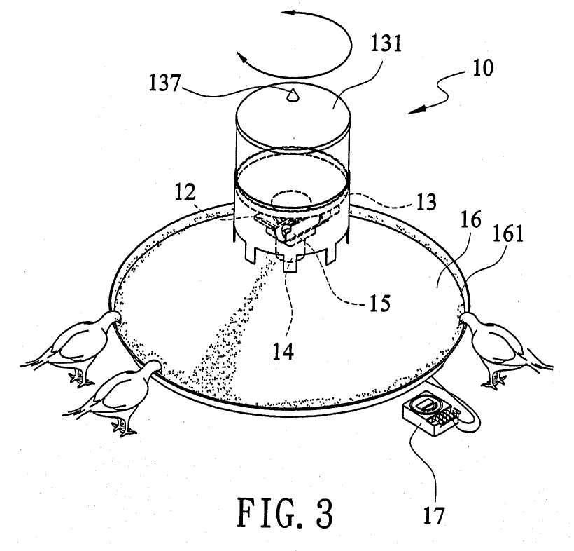

By the construction mentioned above, with reference to FIG. 3, it is seen that according to the present times, during use, the central motor 14 drives base plate 13 rotate and enables feeds to be pushed by feeding device 15 out of container 11 to spread feed uniformly on the surface of distributing disk 16 and lands on the top of furrow 161, so as to provide foods for animals such as bird, thus the object of automatic distribution with preset amount of feed at preset time is achieved.

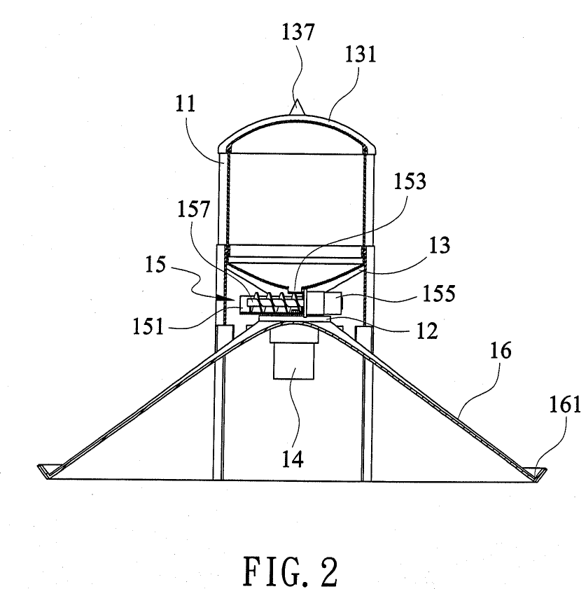

Please refer again to FIGS. 1, 2 & 3, the feeding device 15 is equipped with a pipe 151 for feeds to pass, the pipe 151 has an entrance 153 opposite to the exit of bottom of said base plate 13, enables feeds piled on base plate 13 passes through the entrance 153 into pipe 151, a motor 155 is attached to the end of feeding device 15, said motor 155 drives the feeding screw 157 in the pipe of feeding device 15, and the motor 155 electrically connects to a controller 17, in accordance to the signal from controller 17, said motor 155 activates feeding screw 157 into spiral movement, pushes feeds in the pipe forward for distribution, meanwhile controller 17 sets up the time for activation of the feeding device 15 (e.g. twice a day).

Refer again to FIGS. 1, 2 & 3, outside the surround rotational table 121 is an electric conductor 123, the electric conductor 123 connects to power source and feeding device 15 at the bottom of the base plate 13 has an electric brush 125, the electric brush 125 is electrically connected to power source of the motor 155 and is attached to said electric conductor 123. When the base plate 13 rotates, the electric brush 125 below the bottom of base plate 13 continuously keep in touch with the electric conductor 123 based on the rotation of base plate, then the electric power can be supplied to motor 155 by connection between conductor 123 and electric brush 125.

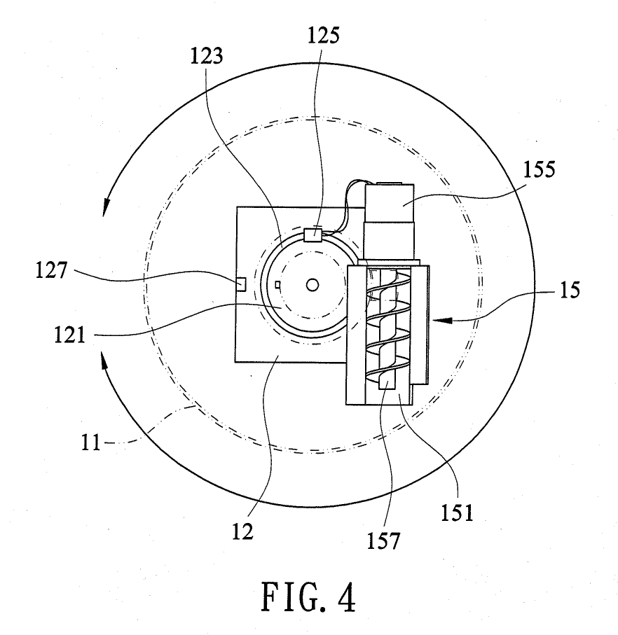

As shown in FIG. 4, the platform 12 is equipped with a touch switch 127, the touch switch 127 connects to controller 17, when the base plate 13 rotates to the point where feeding device 15 touches the switch 127, the controller 17 drives the central motor 14 to rotate in reverse direction based on the signal generated when switch 127 gets touched at this time. As a result, by the driving of motor 14, the base plats 13 can rotate bi-directionally in the container 11.

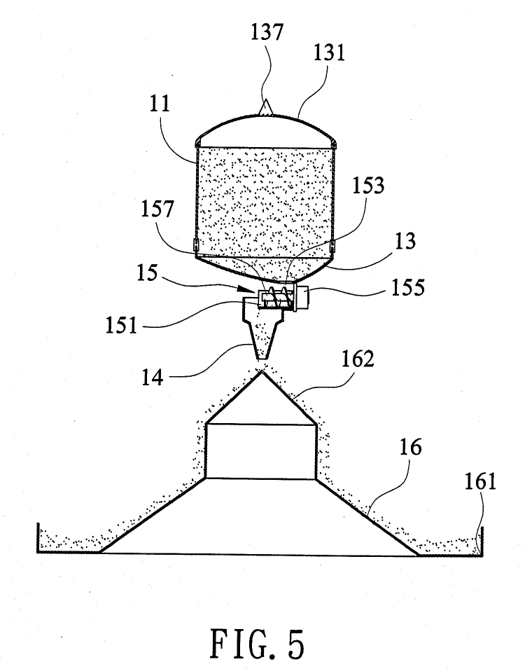

As shown in FIG. 5, the another embodiment of the apparatus for uniformly distributing materials of present invention has a container 11 for storing feeds etc., the container 11 contains a base plate 13 for supporting the feed in the container 11; the bottom of base plate 13 has an exit, outside the base plate 13 opposite to the exit is a feeding device 15, feeds flows down from the exit of base plate 13 into the feeding device 15, and by the pushing force of feeding device, the feeds then is pushed out of the container 11; the apparatus for uniformly distributing materials of present invention has a funnel 14 placed beneath the outlet of the feeding device 15, directly below said funnel 14 is a conical distributing disk 16, the lower outside surrounding portion of the distributing disk 16 is formed as a furrow 161; and, the exit of said funnel 14 is located right above the top of distributing disk with a sharp conical structure 162, the feeds that is pushed out from feeding device 15 can rely to the sharp conical structure 162 of the distributing disk 16 and uniformly falling downward along the distributing disk to the disk furrow 161; the container 11 has a circular cover 131 on the top, the circular cover 131 has a sharp extrusion 137 at its center top for preventing birds (e.g. dove) or other animals from stand on the cover 131; the driving motor 155 of said feeding device 15 is linked to a controller 17, such that the activation time of said driving motor 155 can be set by the controller 17 (e.g. activate twice a day).

According to the construction of the above-mentioned embodiment, during use, feeding device 15 is driven to operate rely on the time set by controller 17, it distributes the feeds that flows down from the base plate 13, evenly across the distributing disk 16 and lands on its furrow 161, to feed birds (e.g. dove) or other animals, thus achieve the object of distributing uniformly the feed at set amount and set time.

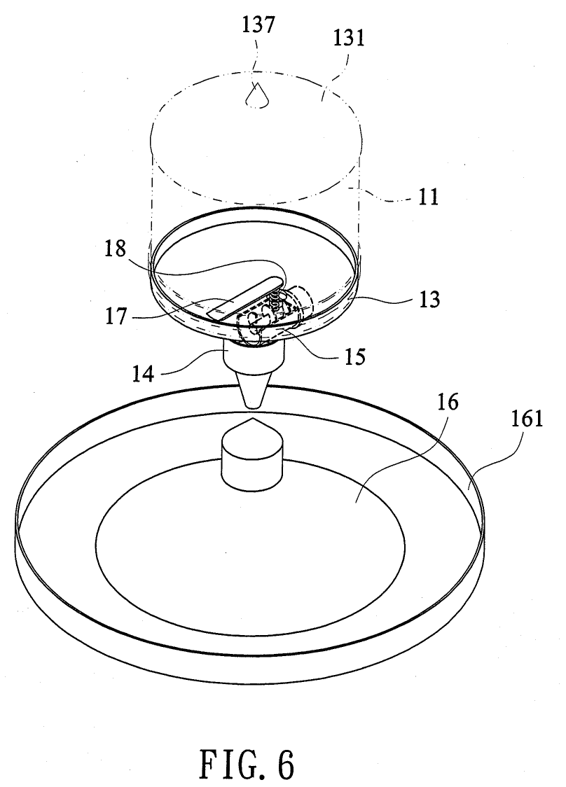

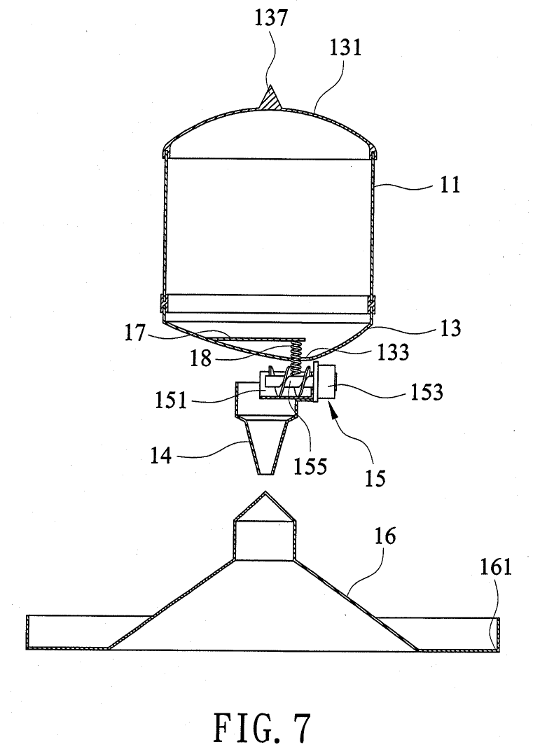

In another practical embodiment of present invention, as shown in FIGS. 6, 7 & 8, the interior wall of container 11 near the exit 133 of base plate 13 has a connecting element 111, the connecting element 111 is connected with an elastic stirring element 18, the end of which touches the spiral of feeding screw inside the feeding device 15.

According to the construction of the above-mentioned embodiment, the feeding device 15 distributes feeds from base plate 13 evenly along the distributing disk and on its furrow 161, to supply food to birds (e.g. dove) and the animals. Meanwhile, said elastic stirring element 18 moves forward and back based on the spiral movement of the feeding screw 157 of feeding device 15, to stir the exit 133 of base plate 13, so to prevent blockage of the exit for feed to flow from the exit into the feeding device 15, and to achieve the object of distributing feeds evenly with set amount and time.

In conclusion, since the construction of present invention is not disclosed and for sale previously, it is then believed the present invention is an invention of novelty.

Although the present invention has been described with a certain degree of particularity, the present disclosure has been made by way of example and changes in details of structure may be made without departing from the spirit thereof.

What is claimed is:

1. An apparatus for uniformly distributing materials, comprising:
a container, for storing materials;
a driving motor, is put beneath the container, for driving a device for pushing the materials out of the container;
a feeding device, is put under the exit formed at the bottom of the container, so that the feeds flowing from the container into the feeding device can be pushed out of container; and,
a conical distributing disk underneath said feeding device, it has a conical top end formed at the central part and a furrow formed at the lower portion surrounding the disk.

2. The apparatus for uniformly distributing materials as claimed in claim 1, wherein near the exit of the container has a connecting element, the connecting element is connected with an elastic stirring element, the bottom end of the elastic stirring element touches the feeding screw of the feeding device, such that the elastic stirring element can moves to and fro based on the rotation of said feeding screw, and thus clear the exit at the bottom of the container to avoid blockage of materials at the exit of container.

3. The apparatus for uniformly distributing materials of claimed in claim 1, wherein the surface of said distributing disk slopes downward from the central part to the surrounding portion.

4. The apparatus for uniformly distributing materials as claimed in claim 1, wherein the feeding device is equipped with a pipe for material to pass, it has an entrance below the exit of the container, so that material in the container can pass through the entrance of feeding device into the pipe of feeding device, attached to the feeding device is a motor, the motor is jointed to a feeding screw inside the feeding device, based on the activation of the motor, the feeding screw rotates, so to deliver materials out of the feeding device.

5. The apparatus for uniformly distributing materials as claimed in claim 2, wherein said stirring element operates when said feeding device is pushing the materials out of it.

6. The apparatus for uniformly distributing materials as claimed in claim 1, wherein the motor for driving said feeding device is connected to a controller, the controller can set the activation time of the motor.

7. The apparatus for uniformly distributing materials as claimed in claim 1, it further comprises:
a funnel, is placed below the feeding device, for receiving the materials to be pushed out of the feeding device and delivering materials onto the central conical top end of said distributing disk;

8. The apparatus for uniformly distributing materials as claimed in claim 7, wherein said feeding device is equipped with a pipe, for the material to pass, the pipe has an entrance below the exit of said container, so that the material in the container can flow down to the feeding device and move from the entrance of the pipe and enters into the pipe, a motor is attached to the pipe for driving said feeding screw in the pipe; by the activation of the motor, the feeding screw rotates, and the material is pushed out from the exit of the pipe.

9. The apparatus for uniformly distributing materials as claimed in claim 8, wherein the motor of the feeding device is connected with a controller by electric wires, such that the activation time of the motor is set by the controller.
